(19) United States
(12) Patent Application Publication
(10) Pub. No.: US 2012/0266766 A1
(43) Pub. Date: Oct. 25, 2012

(54) PRESS WITH A DIRECTLY DRIVEN CRANK DRIVE

(75) Inventor: Matthias Graf, Bretten (DE)

(73) Assignee: Dueffenbacher GmbH Maschinen-und Anlagenbau

(21) Appl. No.: 13/505,830

(22) PCT Filed: Oct. 30, 2010
(86) PCT No.: PCT/EP2010/006647

§ 371 Date: Jul. 16, 2012

(30) Foreign Application Priority Data
Nov. 4, 2009 (DE) 102009051876.2

(51) Int. Cl. B30B 1/06

(52) U.S. Cl. 100/282

(57) ABSTRACT

A press with at least one press frame, a platen mounted therein and a ram driven by means of at least one crank drive, wherein an upper mould part is arranged on the ram and a lower mould part is arranged on the press platen, at least one crankshaft with at least one crank pin and at least one connecting rod is arranged as the crank drive, and at least one direct drive, driving the crankshaft directly, is arranged as the motor for driving the crankshaft. To provide a press in which the input-side forces of the direct drive can be passed on the output side with much less loading for the crankshaft, and at the same time the overall stiffness of the drive train is increased significantly and/or the overall length of the drive train is minimized. With at least one motor arranged within a press, at least two connecting rods on at least one crankshaft, at least one motor is arranged between the connecting rods.

The invention relates to a press having a directly driven crank drive according to the preamble of claim 1.

Manufacturing machines having a reversing ram typically have a motorized drive and a crank drive, which converts the rotational movement of the drive into a linear and reversing movement. Such manufacturing facilities are typically used as presses for reshaping or cutting workpieces. In particular the automobile industry requires press lines, consisting of multiple presses arranged one behind another and an associated transport system, in order, for example, to manufacture complicated geometries, such as fenders, vehicle doors, catalytic converter envelopes, and many other parts from simple delivered coils (flat strip rolls made of metal).

In particular rapidly running press facilities are implemented as mechanical presses as described above.

Many different terminologies have become established in the prior art, so that several terms used herein will be explained and the most well-known synonyms thereof will be described without claiming completeness.

A crank drive according to the invention is a drive which can reshape a rotational movement (of a motor) into a linear movement and is reflected in the technical literature as an eccentric drive or slider crank drive or the like. As explained above, the main task of the crank drive is the conversion of a rotational movement into a translational movement, an eccentric shaft or, as hereafter, a crankshaft being used. An eccentric pin or, hereafter, crank pin is mounted located on the crankshaft outside the rotational axis of the crankshaft, a push rod, referred to hereafter as a connecting rod, typically being arranged on the crank pin. The force flow of the drive can extend from the smallest possible denominators of the crank drive, a crankshaft and a crank pin, up to a ram via multiple stations such as slider cranks, articulated drives, inter alia, or also only one connecting rod.

Furthermore, the term press frame stands for the supporting framework of the press. As defined in the invention, this comprises all press frames in their possible embodiments, for example, constructed press frames made of multiple individual parts (crosshead top and bottom, side columns) and also press frames in window frame design or in tie rod construction. Direct drives and servo presses are distinguished in that various speed gradients may be set via a press stroke (OT-UT-OT) through the use, preferably of DC motors. A pendulum stroke drive is also possible without an ever present danger of overload of partially complex gearwheel or crank drives, if these are provided.

A drive system for a reshaping machine is known from DE 28 40 710, which discloses a direct drive for a drive system of a press. The shaft output of the direct drive has a transmission ratio via a transmission even before the drive force can be transmitted via the shaft to a crank disc and finally to a crank pin.

A direct drive is also known from DE 102 60 127 A1, which is externally flanged onto a shaft and outputs its drive force directly to the crankshaft without the aid of a step-down transmission.

All of these disclosures display a severe disadvantage, that the motor is arranged outside the supporting structures of the press or the press head, respectively. The motor is typically connected for this purpose to the main drive shaft via a clutch or by direct placement on the main drive shaft (flange, clamping set, or splined shaft).

The object of the invention comprises providing a press, in which the drive-side forces of the direct drive can be relayed on the output side with substantially lower load for the crankshaft and simultaneously the overall stiffness of the drivetrain is significantly increased and/or the structural length of the drivetrain is minimized.

The achievement of the object for a press according to the invention is that, if at least one motor is arranged inside a press having at least two connecting rods on at least one crankshaft, at least one motor is arranged between the connecting rods.

The following advantages result with the construction according to the invention: The required installation space of the press having a direct drive can be substantially optimized and reduced in size, and simple measures can be implemented for noise insulation of essentially the drivetrain by encapsulation.

The press can be implemented having a short structural length, which is advantageous in particular in the case of servo presses in press lines for the production of large vehicle body parts. In order to keep the transport paths between the presses as short as possible, the presses must stand closely one after another. The shorter the distance, the more rapid the transfer times. Large presses are typically implemented having an even number of two, four, . . . pressure points (connecting rod or articulated mechanism attachments) on the ram. The distances transversely and longitudinally between the pressure points or the connecting rods, respectively, cannot be selected arbitrarily, but must be selected according to aspects with regard to the reduction of the ram deflection. The safe absorption of off-center forces, in particular in the case of asymmetrical tool or workpiece geometries, is also decisive for the arrangement of the contact points of the connecting rods on the ram of the press. The length of the press head, typically in the passage direction, is determined by the connecting rod distance and the required construction of the main bearings and support structures.

Furthermore, in the advantageous arrangement of the direct drive, in particular within the required support structures of the press, a substantially stiffer drive system and, accompanying this, a reduction of the crankshaft torsion result. If the crankshaft is driven from the outside as the main drive shaft, the torsion of the crankshaft has a disadvantageous effect on the entire drive system. The longer the distance between motor and crank pin or eccentric eye, the softer the drive system, and regulating oscillations occur, because the crankshaft acts like a torsion spring. In the case of a pendulum stroke in particular, severe control and regulating difficulties occur. The readiness to oscillate of the entire drive system having corresponding problems for the support structures or the press frames, respectively, is also problematic and layout-intensive in the design of a press. In the case of a one-sided drive having two connecting rods or two crank pins, respectively, on a shaft, an angle offset also occurs, whereby the connecting rods assume different stroke locations.

Improved control and regulation quality of the system is also displayed in this context through the advantages of the invention. Due to the high stiffness of the drive system and the precisely settable torque and angular position regulation of the motor, no measurable deviations result between two crank pins and therefore on the connecting rods on a crankshaft. The process data can additionally be acquired directly. The press does not have additional mechanical transmission elements (e.g., gear stages) due to the direct drive. The parameters measured on the motor, such as speed, torque, and angular location, can be converted without errors into ram speed, pressing force, and ram position. Corruption due to friction losses or torsion, tooth flank play, etc. are outstandingly eliminated.

Permanent magnet motors have quite a high noise level, in particular at a high drive power. Through the installation in the press head, the noise emission can be easily reduced through relatively simple measures, e.g., by closing the press head on the top and bottom sides.

The overall efficiency of the press is also significantly improved, because significantly fewer unused forces arise due to the torsion or the torque absorption in the bearing in the case of an overhung mounting of the motor. In a particular exemplary embodiment, the stator of the direct drive can be supported in the press head and/or can be provided with a corresponding torque support. In relation to a conventional direct drive, the motor therefore does not have a separate mounting and the mounting of the rotor within the stator is also taken over by the main mounting of the crankshaft. Therefore, additional losses no longer occur. In a particularly preferred exemplary embodiment, in particular in large presses of high tonnage, the direct drive is placed on the supporting part of the crankshaft, i.e., it is located between the main bearings of the mechanical drive which absorb the pressing force. The motor is then preferably also located between the main load-bearing support structures (at least two press frames of the press) and concentrically to the main drive shaft (crankshaft). The connecting rods, or in articulated drives, the pivot levers which lead to the connecting rods, can either be located on the right and left of the motor and therefore between motor and main bearing (support structure of the press head) or on one side between the motor and one of the main bearings.

Further advantageous measures and embodiments of the subject matter of the invention are disclosed in the subclaims and the following description with the drawing.

In the schematic figures:

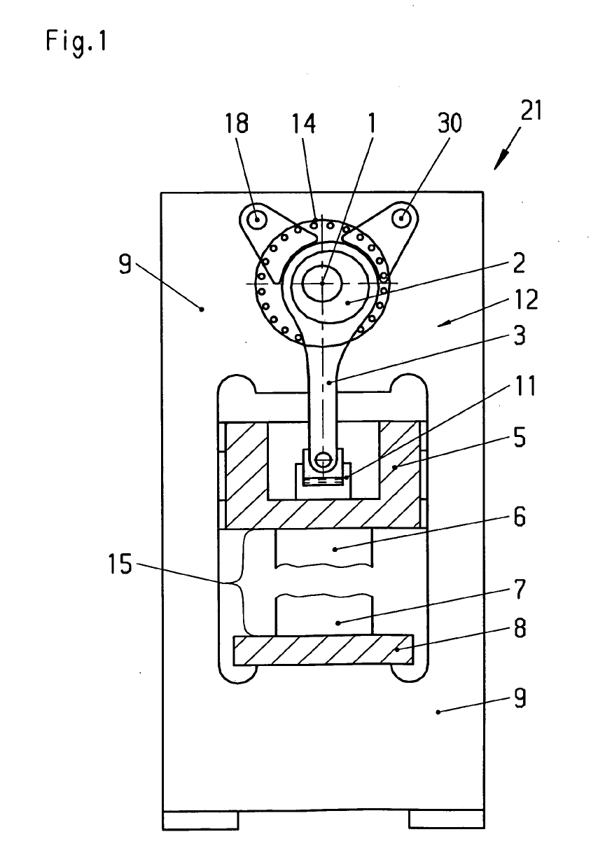

FIG. 1 shows a mechanical press having a press frame and a press table, in the upper area of the press, in the head area, the drive system being located, consisting of two crank drives arranged one behind the other, each having a crankshaft, a crank pin, and a connecting rod operationally linked to a ram,

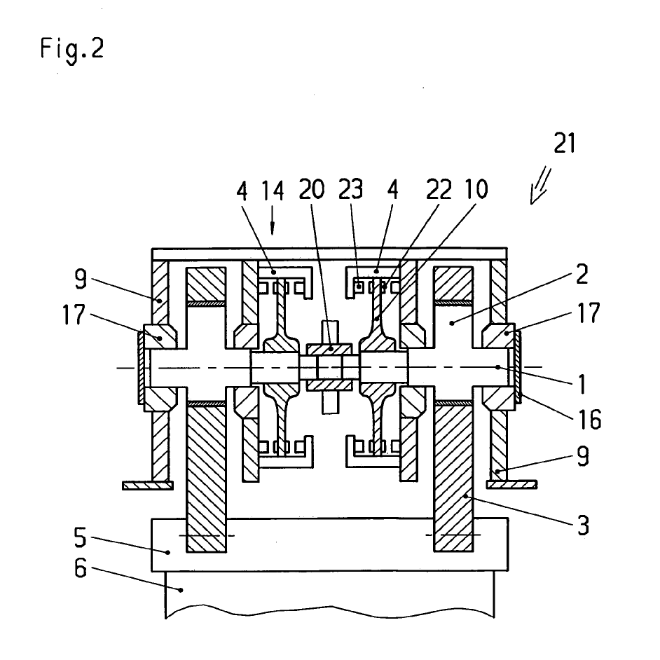

FIG. 2 shows the same embodiment in a side view according to FIG. 1, with illustration of the two crank drives arranged adjacent to one another, one separate direct drive per crank drive being arranged for the separate drive,

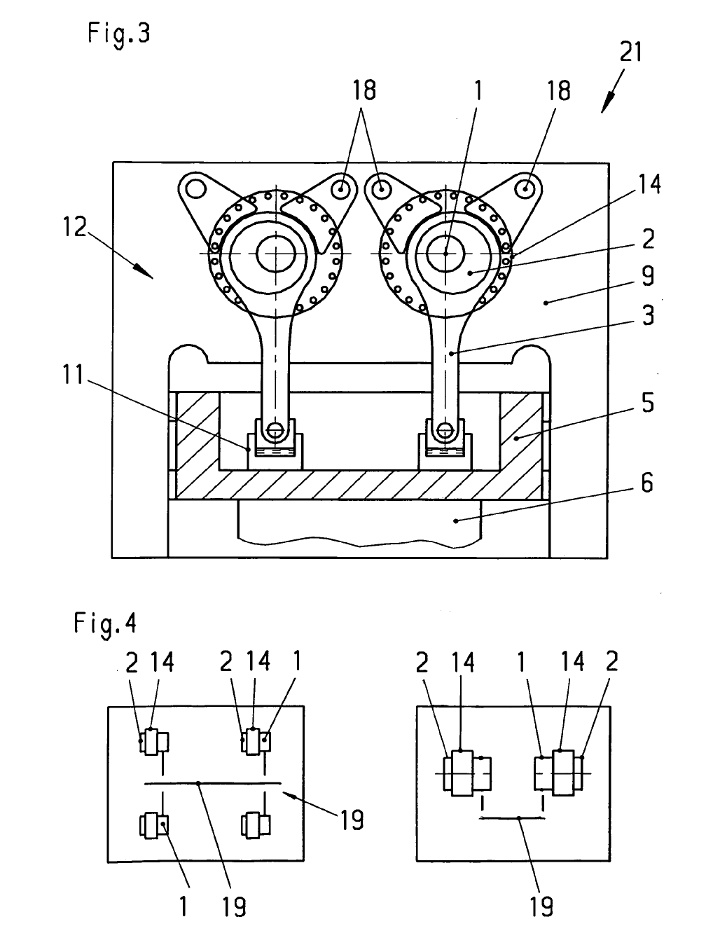

FIG. 3 shows a further possible embodiment having four driven connecting rods, two crank drives again being arranged one behind the other, and

FIG. 4 shows two illustrations of possible forced couplings for parallel running of the ram in a top view for the examples according to FIG. 3 (on the left) and FIGS. 1 and 2 (on the right).

According to FIG. 1, the press 21 consists at least of a press frame 9, a press table 8 mounted therein, and a ram 5 driven by means of at least one crank drive 12. This press 21 is preferably used for breaking in tools 15 or for producing workpieces (not shown) by means of at least one manufacturing method in a tool 15, the tool consisting at least of a tool top part 6 on the ram 5 and a tool bottom part 7 on the press table 8. At least one crankshaft 1 having at least one crank pin 2 and at least one connecting rod 3 is arranged as the crank drive 12, as the motor 14 for the drive of the crankshaft 1, at least one direct drive, which directly drives the crankshaft 1 and is mounted in a mount 18, being provided. In the crank drive 12, which is also referred to as an eccentric drive, instead of the connecting rod 3 or between the connecting rod and the crank pin, an articulated drive or a slider crank or similar intermediate devices can be arranged, which are typically used for stroke height adjustment, for safety reasons, or to set the sinus curve of the movement path of the ram. In particular to drive a toggle lever drive, an articulated drive, a further crank drive, or a combination thereof, the crank drive 12 is arranged operationally linked thereto, these in turn being arranged operationally linked on the output side to the ram 5.

FIG. 2 shows the same embodiment in a side view according to FIG. 1. In this special exemplary embodiment, the motors 14 are arranged as a direct drive between the connecting rods 3 of the individual ram attachments. In the present example, the two connecting rods are located on two separate crankshafts 1, which are mounted accordingly in the press frame 9 of the press 21. A possibly required forced coupling 19 between the two connecting rods is not shown for reasons of clarity and is located, for example, in the right drawing of FIG. 4. It is obvious from FIG. 2 that the motors 14 consist of a stator 4 arranged on the press frame 9 and a rotor 10 arranged on the crank drive 12, or the crankshaft 1, respectively. In an advantageous manner and to optimize the center of gravity of the press 21, both drives are arranged between the connecting rods here. This also results in advantages in particular in the lines of the motors 14, which are effectively kinematically separated from one another by an intermediate bearing 20 mounted in the press frame 9. In an alternative, the crankshaft can also be made continuous, of course, and only one motor 14 or even multiple motors can be arranged, depending on the specifications of the press 21. A forced coupling of the two crankshafts 1 can be implemented as a coupling axis arranged parallel to the crankshaft 1 having corresponding spur gear connection to the individual crankshafts or can be implemented as a direct frontal connection of the two crankshafts. This does not necessarily have to be arranged inside the intermediate bearing 20. Furthermore, advantageous embodiments of the press 21 are found as separate bearings 17, which are arranged in corresponding large installation openings of the press frame 9 and have a bearing cover 16.

Two illustrations of possible forced couplings for parallel running of the ram in a top view for the examples according to FIG. 3 (on the left) and FIGS. 1 and 2 (on the right) are shown in the two drawings of FIG. 4. The drives or the motors 14 are at least partially, but particularly preferably completely arranged between the connecting rods 3, or their crank pins 2, respectively. The forced coupling can be implemented via mechanical spur gears having corresponding engagement possibilities on spur wheels of the crankshafts 1. Alternatively or in combination, electronic forced coupling of the frequency rectifiers or the control unit, respectively, can be implemented for the motors 14.

Further preferred exemplary embodiments are mentioned hereafter, which, furthermore, do not necessarily have to be implemented in detail in the drawing. Thus, the motor 14 is arranged substantially adjoining, at least adjacent to, or preferably in one piece with a crank pin 2 on the crankshaft 1. Depending on the embodiment and definition location, a so-called crank disc can be integrated within or on the motor. The stator 4 of the motor 14 is preferably implemented so that it takes over the function of the crank disc and guides the crank pin 2 outside the center axis of the crankshaft 1. A mount 18, which is connected to the press frame 9, is provided for torque compensation and/or mounting of the motor 14. The motor 14 can be implemented as a direct drive of a stator 4 having a drive winding 23 and a rotor 10 arranged therein having permanent magnets 22 and would then be implemented as a permanent magnet motor. Fundamentally, in the case of at least two crank pins 2 on the crankshaft 1, at least one motor 14 can be arranged between the crank pins 2. In particular in the case of a plurality of motors or crank pins 2, a symmetrical arrangement within the press 21 or the crankshaft 1 is preferred. It can thus be provided that in the case of multiple motors 14 and multiple crank pins 2, at least two motors 14 are arranged symmetrically to one of the center axes of the press frame 9 and/or one of the center axes of the ram 5 and/or to the longitudinal center point of the crankshaft 1 and/or to the arrangement of the crank pins 2 on the crankshaft 1. It would also be advantageous if the rotor 10 of the motor 14 and the crankshaft 1 and/or the crank pin 2 consist of a one-piece machine element. A height adjustment for the stroke of the ram 5 can also be arranged in the crank drive 12. An overload safety 11 is to protect the press from greater damage in the event of interference and decouples the connecting rod 3 from the ram 5 in case of damage. For torque compensation, the stator 4 of a motor 14 can be arranged on a bearing on the rotor 10 and a torque support having connection to the press frame 9 can appear advisable for compensation of the occurring torques on the stator 4. In particular if two crankshafts 1 are arranged, each stator 4 of one motor 14 can be arranged on one bearing on the rotor 10 and, for compensation of the occurring torques on the stators 4, a torque support having connection to the motor 14 can be arranged on the adjacent crankshaft 1, which allows mutual support of the torques. This has advantages in particular with respect to the vibration transmission to the press frame 9. As shown, the motor 14 and the crank drive 12 can be arranged inside a support structure formed by the press frame 9, which is preferably designed for a pressing force of greater than 200 tons, more preferably greater than 500 tons, particularly preferably greater than 800 tons. In particular in such presses, the stroke of the ram 5 is possibly greater than 300 mm, preferably greater than 600 mm, particularly preferably greater than 900 mm. The press 21 is preferably used for a manufacturing method, which at least comprises the shaping, isolation, joining, coating, and/or reshaping, in particular metal reshaping. In particular, the press 21 can be arranged as a head press or as an breaking-in press for tools of a press line and/or as at least one transfer press in a transfer press line and/or as a pre-press in the manufacturing direction before a transfer press line.

The bearings 17 of the crankshaft 1 are preferably arranged in bearing shields, which are removable from the press frame 9, so that an opening having an installation diameter in the press frame can be opened, which with respect to the diameter preferably is equal to or greater than the diameter of the rotor 10 on the crankshaft 1 or respectively corresponds to the largest diameter on the crankshaft 1. It can be helpful during the installation that a crankshaft 1 which is divided at least once in the longitudinal axis is arranged in the press, which has, for example, a flange connection, removable bearing pins, or a shaft/hub connection. The rotor 10 is particularly preferably permanently arranged on the crankshaft 1. For this purpose, a shrink fit, a welded connection, a soldered connection, a friction welded connection, a glue joint, and/or another inseparable joint bond can be used for connecting the rotor 10 to the crankshaft 1. A preferred embodiment of the rotor 10 would comprise grooves and/or depressions for accommodating the permanent magnets 22. Only after the manufacturing of the one-piece machine elements are these magnets to be inserted therein.

In particular in the case of two separate but axially aligned crankshafts 1, at least one motor 14 is to be arranged as a direct drive between the connecting rods 3. In the case of demanding geometries of the connecting rod arrangements, it would be advantageous if, in the case of two separate crankshafts 1, which are located in one plane, however, according to a coaxial projection of the two axes of the crankshafts 1 in one axis, at least one motor 14 is arranged as a direct drive between the connecting rods 3. A coaxial projection is understood to mean that the two coaxially arranged axes of the spaced-apart crankshafts are displaced parallel to one another until they are located in one axis. It may thus also be recognized here when a direct drive is arranged “between” two crankshafts, even if these crankshafts are not in one piece.

### LIST OF REFERENCE NUMERALS: DP 1393

1 crankshaft
2 crank pin
3 connecting rod
4 stator
5 ram
6 tool top part
7 tool bottom part
8 table
9 press frame
10 rotor
11 overload safety
12 crank drive
13
14 motor
15 tool
16 bearing cover
17 bearing
18 mount
19 forced coupling
20 intermediate bearing
21 press
22 permanent magnet
23 drive winding

1. A press having at least one press frame, a table mounted therein, and a ram driven by means of at least one crank drive for breaking in tools or for producing workpieces by means of at least one manufacturing method in a tool, a tool top part being arranged on the ram and a tool bottom part being arranged on the press table, at least one crankshaft having at least one crank pin and at least one connecting rod being arranged as the crank drive, and at least one direct drive which directly drives the crankshaft being arranged as the motor for the drive of the crankshaft, wherein if at least one motor is arranged inside a press having at least two connecting rods on at least one crankshaft, at least one motor is arranged between the connecting rods.

2. The press according to claim 1, wherein, in the case of two separate but axially aligned crankshafts, at least one motor is arranged as a direct drive between the connecting rods.

3. The press according to claim 1, wherein in the case of two separate crankshafts, which are located in one plane, however, according to a coaxial projection of the two axes of the crankshaft in one axis, at least one motor is arranged as a direct drive between the connecting rods.

4. The press according to claim 1, wherein at least one mechanical and/or electronic forced coupling is arranged in the case of two separate crankshafts.

5. The press according to claim 1, wherein the motor is arranged substantially adjoining a crank pin on the crankshaft.

6. The press according to claim 1, wherein a rotor of the motor is arranged on the crankshaft.

7. The press according to claim 1, wherein, in the case of multiple motors and multiple crank pins, at least two motors are arranged symmetrically to one of the center axes of the press frame and/or one of the center axes of the ram and/or to the longitudinal center point of the crankshaft and/or to the arrangement of the crank pins on the crankshaft.

8. The press according to claim 1, wherein a rotor of the motor and the crankshaft and/or the crank pins consist of a one-piece machine element.

9. The press according to claim 1, wherein a vertical adjustment for a stroke of the ram is arranged in the crank drive.

10. The press according to claim 1, wherein, to drive a toggle lever drive, an articulated drive, a further crank drive, or a combination thereof, the crank drive is arranged operationally linked thereto, these in turn being arranged operationally linked on an output side with the ram.

11. The press according to claim 1, wherein a permanent magnet motor is arranged as the motor.

12. The press according to claim 1, wherein the motor and the crank drive are arranged inside a support structure formed by the press frame.

13. The press according to claim 1, having a pressing force of greater than 200 tons, preferably greater than 500 tons, particularly preferably greater than 800 tons.

14. The press according to claim 1, having a stroke of the ram of greater than 300 mm, preferably greater than 600 mm, particularly preferably greater than 900 mm.
